(19) United States
(12) Patent Application Publication
(10) Pub. No.: US 2026/0208303 A1
(43) Pub. Date: Jul. 23, 2026

(54) PALLET-SWITCHING SYSTEM AND CONVEYOR

(71) Applicant: CONCEPT & FORME DEVELOPPEMENTS SA, Profondeville (BE)

(72) Inventor: Gérard PITANCE, Profondeville (BE)

(21) Appl. No.: 19/158,200

(22) PCT Filed: Jan. 30, 2024
(86) PCT No.: PCT/EP2024/052148

§ 371 Date: Aug. 20, 2025

(30) Foreign Application Priority Data
Feb. 24, 2023 (EP) 23158440.0

(51) Int. Cl. B23K 37/04; B23K 26/38; B23K 37/02; B65G 37/00

(52) U.S. Cl. CPC B23K 37/0461; B65G 37/005; B23K 26/38; B23K 37/0229; B65G 2201/0267

(57) ABSTRACT

A system having an automated tower or vertical magazine storage tower may include palletization system consisting of pallets, as well as a pallet-swapper incorporated at the base of the tower. The tower uses palletization to store and transport loads. The swapper includes a supporting structure, at least two movable frames each having pairs of rollers on the lateral sides thereof, and a conveying system located on the bearing structure to allow the movement of the movable frames and connected to a drive shaft. Each movable frame is capable, in use, of carrying a single pallet, loaded or not, the pallet being separate from the movable frame that supports it.

### FIELD

The present disclosure primarily relates to the field of automated storage warehouses, comprising towers with horizontal racks supporting standardized metal pallets, on which stored goods rest. The towers are generally arranged linearly in one or two rows, along which an elevator/de-elevator also called a “stacker crane” circulates, the stacker crane being equipped with a chain mechanism that allows the introduction or extraction of pallets and their movement to any other location in the warehouse. Various auxiliary devices make it possible to transport goods from the workshop to the warehouse and vice versa.

More specifically, the present disclosure relates to a new principle of pallet conveyor that facilitates the optimization of goods-transfer operations between the storage warehouse and the workshop workstations.

### BACKGROUND

In production workshops, the operating rates of workstations and machine tools are often hindered by machine stoppages due to handling operations related to the supply of raw materials and the removal of parts after shaping. Consequently, optimizing supply and removal flows so as to increase tool productivity and operating rates is a well-known issue, particularly when shaping metal sheets, cutting, welding and machining.

These machines are increasingly automated so as to reduce the role of machine operators and thus the number of manual operations to be performed during a production cycle. In a workstation, part of the surface is reserved for pallets of materials or parts to be shaped. Another part of the surface is dedicated to the pallets that will receive the shaped parts. Whether these cells are served by operators or by more automated systems, their operating rate will depend on the availability of operators in charge of handling or that of the stacker crane if the production cells are connected to an automated warehouse. Consequently, there is significant interest in optimizing the operating rates of workstations by increasing the speed of supply and removal operations.

Manufacturers of automated warehouses offer various devices to manage the incoming and outgoing pallet flows between the warehouse and the workstations connected thereto. FIG. 1 shows depalletization interfaces that allow the separation of a bundle of metal sheets from the wooden pallet used for its transport so as to transfer it to a standardized warehouse pallet. There are also chain devices, as shown in FIG. 2, placed on the external face of a warehouse tower so as to allow the extraction of a pallet from the tower by translating it horizontally to introduce it into a production cell, for example. These systems have the drawback of being dependent on the availability of the stacker crane when the removal of the pallet from the workstation is required. The operating rate of the workstation and the machine tool is doubly hindered, on the one hand, by the time required to remove the pallet to be restocked in the warehouse and, on the other hand, by the time needed for the stacker crane to bring a new pallet and introduce it into the workstation.

Some more recent devices, as illustrated by FIGS. 3 and 4, include two trolleys of different heights moving respectively on their own rails, generally placed on the ground. The lower trolley is narrower than the higher trolley. This device can therefore accommodate two pallets and allows the introduction or removal of one pallet or the other, automatically and alternately, thereby reducing the waiting time.

However, the place taken by the stacker crane structures and its pallet extraction mechanism requires a minimum height below which the lowest pallet is no longer accessible to the extraction system. Thus, the height from the ground of the first pallet support (measured at the bearing surface) generally varies between 50 and 65 cm depending on the manufacturers. Moreover, the height of the pallet circulating at the upper level is calculated by adding the height of the first-level pallet, the potential place taken by the loads it is intended to convey, and the thickness of the upper mechanism added to the thickness of the second pallet. If a payload height of 20 cm is considered, the usable height of the upper pallet will therefore be between 85 and 100 cm.

Such a height difference between the low pallet and the high pallet may prove problematic for more than one reason:
when the workstation is automated, the programming of gripping and depositing operations must take into account two height criteria;
The programming would be even more complex if the cell required a double connection to the automated warehouse, which is among others the case in punching cells, where it is necessary to introduce or remove bundles of metal sheets via one of the conveyors and to introduce or remove pallets intended for cut parts via a second conveyor. In this case, it is extremely difficult to foresee the different possible combinations of pallet heights. Indeed, the pallet of the first connection could be in a high position when the pallet of the second connection is in a low position and vice versa, these height parameters being variable for each of the connections throughout the production cycle;
In a bending cell, the height separating the low pallet from the high pallet should be significantly increased to allow the passage of large bent parts when the pallets cross, particularly if they have been stacked;
Still in an automated bending cell, the volume taken by a two-level conveyor could prove problematic during bending operations, when the robot manipulates large-dimension bent parts requiring a well-cleared space;
As illustrated in FIG. 3, double trolley systems requires widening of the towers to which they are integrated as well as a consequent reinforcement of the tower structures. Their integration is therefore only possible at the expense of standardizing tower widths or by oversizing the entire warehouse towers. This aspect is of great importance if one takes into account the fact that the number of machines, or cells, connected to the automated warehouse can grow as the company develops, and production capacity thus needs to be increased by adding new machines. Connecting a new machine to the warehouse will always be problematic if it is necessary to incorporate a widened tower into an already built warehouse. In this case, it implies dismantling the other warehouse towers so as to displace them or sacrificing one or more towers to allow the positioning of one or more widened tower(s). This problem will arise each time a new machine, or cell, has to be connected to the automated warehouse, causing costly dismantling and reassembly work as well as major production disruptions.

FIGS. 5 and 6 describe two other solutions, specifically two devices that can be installed a posteriori at any location in the warehouse and include a so-called “buffer” pallet. However, the substitution of one pallet by another using these types of devices requires respectively 4 to 6 movements and 2 to 3 motors. These two devices also do not seem suitable for restocking larger loads, such as stacks of bent parts for example. Moreover, these solutions are not adaptable to different types of load supports.

Another reason justifies the search for the greatest possible standardization of warehouse structures and their control systems. Sheet metal workshops face difficult decisions when the acquisition of new machinery is needed. In fact, the problem is not limited to choosing the machine that best meets their expectations, but also includes selecting machines with standard control systems that can be adapted to the automated storage warehouse chosen by the workshop. Choosing a warehouse manufacturer often means having to then choose machines from that same manufacturer or forbidding oneself to connect a machine from another manufacturer to the warehouse. One of the inventors'aims was to develop a versatile, simple, flexible interface that can be adapted to machines from different manufacturers to give metal workshops complete freedom and then choose the machines most in line with their needs and expectations.

During the design of a productive conveyor that would allow optimal exchange between a work cell and an automated warehouse, the inventors applied principles generally known from the state of the art related to conveyors. For example, the movement of loads is constantly parallel in two planes located at different levels, with a duplication of transfer rails between the two levels, cam systems guiding the load supports, etc. Several prior and already old documents adopt these principles with their mechanical specificities depending on applications, which can be related to very different technical problems now solved, such as a garage maximizing the number of vehicles parked in a given volume or the conveyance of bakery products in a masonry oven.

Thus, document JP S49 38374 A describes a garage for motor vehicles. The loads that constitute the vehicles enter and exit their parking spot laterally and perpendicularly to the direction of movement of the load supports. It should be noted that the loads are placed directly on the load supports and not on auxiliary supports independent of said load supports.

U.S. Pat. No. 2,369,840 A describes a bakery oven also integrating a top/bottom-type conveyor with multiple supports made of a metal mesh stretched over a frame and on which the goods to be baked are directly deposited. These supports are successively brought opposite an opening, thereby allowing the extraction of baked goods using a spatula, as bakers usually do.

### SUMMARY

The present disclosure is aimed at making use of certain known principles of “top/bottom” or “return-below” conveyors, combining them with new principles, so as to satisfy specific operational constraints of the intended application and thereby solve problems that did not arise in known solutions of the prior art.

The present disclosure is in particular aimed at optimizing the operating rate of a workstation by instant availability of what is required for its operation. The idea is to duplicate the incoming and outgoing flows of a workstation so as to have a buffer stock at any time and thus guarantee practically uninterrupted operation of the machine and its operator or the cell if the machine is automated.

The present disclosure is also aimed at allowing simultaneous permutation of at least two pallets, one pallet taking the exact place of the one it replaces or the one that follows, and vice versa, without changing the orientation of the load throughout the operation.

Another aim is to make it possible to integrate a pallet switcher into the support structures of one or more storage tower(s) of an automated warehouse to ensure flexible handling operations located at the interface of the automated storage warehouse and the different production cells connected to it.

Another important aim of the present disclosure is to provide a switcher combining great robustness and great compactness to make it adaptable to a wide variety of devices compared to the very specific switching devices of the state of the art.

In the solution according to the present disclosure, unlike other known “top/bottom” conveyors, the load supports are replaced by mobile frames that are not designed to directly receive the loads to be conveyed, but are specifically designed to receive, on a case-by-case basis, different types of auxiliary palletizations constituting the supports of the loads to be moved. These direct supports are preferably made of standardized pallets or standardized supports, adapted to the materials and/or parts to be conveyed, these different standardized supports being adapted to the different handling systems used in production workshops, such as forklifts, automated warehouse elevators/de-elevators, automated vehicles (AGV or AMR), etc.

This technical difference is an essential characteristic of the present disclosure, around which the other technical characteristics of the present disclosure revolve. Thanks to this characteristic, it is possible to dissociate the auxiliary load support (such as a pallet) from the mobile frame that supports it and facilitates movement by rolling, sliding, or lifting using common devices, such as scissor devices called “pantographs”, chain drive devices, or even cylinder devices, any of said devices being compatible with the structures of the switcher (also called a “permutateur” in French due to misuse of language coming from English).

Another characteristic of the present disclosure, correlated to the preceding one, lies in the possibility to connect several juxtaposed switchers to the standardized towers of a linear automated warehouse, as represented in FIG. 30. In this case, the standardized support structures of the switcher are designed to allow the integration of two mechanisms (FIG. 24) while avoiding that the place taken by the two juxtaposed mechanisms exceeds the dimension of the support structures of the warehouse towers, i.e., approximately 20 cm. This characteristic is particularly important when the production cell involves the automatic management of several types of incoming and outgoing flows.

Another characteristic of the present disclosure lies in the possibility of dividing into two distinct elements the beams forming the support structure of the switcher as illustrated by FIG. 27, so that one of these two elements is an integral part of the standardized support structures of the warehouse tower. The second element of the switcher support structure thus ensures the mechanical functions related to it, this second element being connectable, a posteriori, to the support structures that are an integral part of the standardized towers of the warehouse so as to combine the standardization of the switcher structures with the standardization of the tower structures. This makes it possible to connect new production cells equipped with switchers at any location in the warehouse, without incurring costly work or production disruptions.

A significant advantage arises from the characteristic described in the previous paragraph in terms of load distribution on concrete. Indeed, the flexural strength of the lower beam allows uniform distribution of the weight of the towers over the entire surface of the wall footing in contact with the concrete and avoids the punching effect that can occur when the load is localized at the column feet, as is generally the case.

The present disclosure is also characterized by the fact that the number of mobile frames comprised in the switcher can be directly linked to the number of successive operations included in the operating process of the machine to which the switcher is associated. In a laser-cutting machine, it may be interesting to provide a switcher including three mobile frames, each supporting a comb table typical of the tables used with this type of machine. For example, as represented in FIG. 26, each of the tables corresponds to a step in the machine operating process. A first table supports the sheet that has just been cut, a second table supports the sheet being cut, and a third table supports the sheet being processed. The advantage of the switcher, in this case, is that it performs the permutation of the three tables in a single operation.

Moreover, the pallet switcher differs from the other principles previously described thanks to the load-bearing function of its structures, which can be combined with the support structures of the storage towers to form a coherent whole so as to reduce the footprint of the support structures of the control systems specific to the different types of machines to be connected to the storage warehouse as well as to reduce costs. Thus, the support structures of the pallet switcher may be used as a base for the linear movement axis of a robot serving a punching or a laser-cutting machine (see FIG. 28) or even for the load-bearing structures of a suspended robot (see FIG. 29).

Under these conditions, a first aspect of the present disclosure pertains to a system comprising a storage tower of an automated tower or vertical warehouse, comprising a palletization system consisting of pallets, as well as a pallet switcher integrated at the base of said tower, said tower using palletization for the storage and transport of loads, said switcher comprising:
A support structure having beams of sufficient dimensions to receive the load represented by the weight of the storage tower itself, to which a maximum weight of pallets loaded with their content is added;
At least two mobile frames, each comprising a first pair of rollers and a second pair of rollers on its lateral sides;
A conveyor system located on the support structure, thereby allowing the movement of the mobile frames, and connected to a drive shaft;
A set of guiding grooves forming a closed loop with separate rails and a guiding path for each mobile frame, said set of guiding grooves comprising a first path and a second path, said grooves accommodating the rollers of the mobile frames; and
A cam-switching system for the pairs of rollers in the guiding grooves; the cam-switching system being suitable for guiding, in use, the pairs of rollers so that the first pair takes the first path and the second pair takes the second path so as to move the mobile frames along the closed loop while remaining permanently parallel to each other horizontally and oriented in the same direction;
   each mobile frame being suitable for, in use, carrying a single pallet, loaded or not, said pallet being distinct from the mobile frame that supports it, the beams of the support structure comprising the assembly of at least three metal sheets, each of the sheets comprising specific cutouts forming, in combination, the guiding grooves and the necessary housings for the cam-switching system of the pairs of rollers in the guiding grooves.

According to preferred embodiments of the present disclosure, the system further comprises one of the following features or an appropriate combination thereof:
The beams of the support structure have dimensions sufficient to receive the load represented by the weight of the storage tower itself, to which a weight of pallets loaded with their content amounting to 2.5 tons is added;
The system comprising at least one standard storage tower without pallet switcher, wherein the beams of the support structure of the pallet switcher are symmetrical and have a geometry that allows the duplication of the conveyor system when several switchers are juxtaposed laterally, while respecting the height alignment with the standard storage tower and with the storage tower comprising a pallet switcher integrated at its base;
The system comprising at least one standard storage tower without pallet switcher, wherein the height of the storage tower associated with a switcher is reduced by the height of said switcher so that the storage tower is aligned with the height of a standard storage tower, the storage levels being also aligned relative to the standard tower without pallet switcher;
The system comprises specific pallets with hooks supported by profiles, and the mobile frames of the switcher comprise lateral crosspieces aligned with the profiles supporting the pallets with hooks so that the pallets with hooks can be transferred, in use, from the switcher to the storage tower of the automated warehouse and vice versa, given that they are compatible with the switcher and the storage tower;
The storage tower comprising equidistant pallet-storage levels, the distance between the first storage level and a maximum height of the mobile frame in the tower being greater than the fixed distance between two storage levels of the tower so as to also exchange larger parts between the storage tower and a workstation outside the storage tower;
The first pair of rollers comprises an extended axis and the second pair of rollers comprises a protruding axis, and the conveyor system comprises a plurality of sprockets, the axes of the mobile frame being in the median plane of the sprockets, in a position that corresponds to the most forward position of a pallet on the warehouse side, the pallet carried by the mobile frame being then vertically aligned with the other pallets of the warehouse, this pallet being thus also accessible to the extraction system of a warehouse stacker crane.

Another aspect of the present disclosure relates to automated manufacturing equipment.

Another aspect of the present disclosure relates to a switcher.

Another aspect of the present disclosure relates to laser-cutting equipment.

The present disclosure also pertains to the use of the pallet switcher described above.

### BRIEF DESCRIPTION OF THE DRAWINGS

FIG. 1 illustrates a depalletization interface of the prior art, which allows the separation of a bundle of metal sheets from the wooden pallet used for its transport so as to transfer it to a standardized pallet of the warehouse.

FIG. 2 represents a chain device of the prior art, placed on the external face of a warehouse tower, thereby allowing the extraction of a pallet from the tower by horizontal translation.

FIG. 3 shows a prior art device to accommodate two pallets and introduce or remove one of the pallets alternately and automatically.

FIG. 4 represents another prior art device to accommodate two pallets and introduce or remove one of the pallets alternately and automatically.

FIGS. 5 and 6 describe two other prior art devices that can be installed a posteriori at any location in the warehouse and include a buffer pallet.

FIG. 7 illustrates a general three-dimensional view of an embodiment of the pallet switcher/conveyor implemented according to the present disclosure, the system comprising in this case two mobile frames.

FIG. 8 shows an exploded view of the switcher depicted in FIG. 7.

FIG. 9 represents a three-dimensional view of a first example of a mobile frame of the pallet conveyor according to the present disclosure (the mobile frame is shown topped with a pallet).

FIG. 10 illustrates detailed views of the rollers of the mobile frame depicted in FIG. 9.

FIG. 11 shows a detailed view of the first example of a mobile frame combined with the conveyor system of the pallet switcher/conveyor according to the present disclosure.

FIG. 12 corresponds to FIG. 11, but with the detail of the reference numbers.

FIG. 13 represents a plan view of an example of a transmission system of the pallet switcher/conveyor according to the present disclosure.

FIGS. 14, 15 and 16 illustrate different embodiments of the support structure of the switcher. The support structure of FIG. 14 is made of standardized and normalized hot-rolled profiles. The support structure of FIG. 15 is made of a machine-welded assembly. The support structure of FIG. 16 is made of bent sheet-metal profiles in a “C” shape and placed back to back.

FIG. 17 shows the formation of the guiding grooves for the rollers and the cam housings using three metal sheets assembled together.

FIG. 18 represents an elevation view of the different types of rails of an example of a conveyor system of the pallet switcher/conveyor according to the present disclosure.

FIG. 19 is another view of the first example of a mobile frame according to FIG. 9, designed to receive load supports consisting of standardized pallets typical of automated storage warehouses. In this case, the arms of the mobile frame serve as a bearing race for metal pallets of the warehouse.

FIG. 20 illustrates a second example of a mobile frame according to the present disclosure, this one being open on one side to easily deposit a pallet using a forklift for example.

FIG. 21 shows a third example of a mobile frame of the conveyor according to the present disclosure.

FIG. 22 represents a three-dimensional view of a switcher according to the present disclosure comprising two mobile frames moving symmetrically and oppositely to substitute for each other.

FIGS. 23A to 23H illustrate the successive steps of a complete permutation cycle of a mobile frame with different switches, according to an embodiment of the present disclosure.

FIG. 24 shows a detailed view of the insertion elements of a switcher according to the present disclosure in an automated warehouse tower.

FIG. 25 represents a three-dimensional view of a pallet switcher according to the present disclosure, comprising three mobile frames, each supporting a comb table.

FIG. 26 illustrates a three-dimensional view of the switcher depicted in FIG. 25, wherein the first frame supports the metal sheet that has just been cut, the second frame supports the sheet being cut, and the third frame supports the sheet being processed.

FIG. 27 shows an automated warehouse comprising at least one tower, the beams forming the support structure of the switcher, the beams being divided into two distinct elements so that one of these two elements is an integral part of the standardized support structure of the warehouse tower.

FIG. 28 represents an automated warehouse with a switcher according to the present disclosure, the support structures of which are used as a base for the linear movement axis of a robot serving a punching or a laser-cutting machine.

FIG. 29 illustrates an automated warehouse with a switcher according to the present disclosure, the support structures of which are used as a base for the support structures of a suspended robot.

FIG. 30 shows a linear automated warehouse comprising several switchers according to the present disclosure, connected to each other and juxtaposed to the standardized towers of the warehouse (only one complete switcher is represented in the figure).

FIG. 31 represents a three-dimensional view of a pallet switcher according to the present disclosure, with three sets of two mobile frames, the mobile frames being open on one side to easily place a pallet using a forklift.

FIG. 32 illustrates a three-dimensional view of a pallet switcher according to the present disclosure with two mobile frames, associated with a storage tower of a linear automated warehouse.

FIGS. 33A and 33B show a segment of an automated warehouse wherein the workstation, such as a bending cell, is connected by a switcher-respectively two switchers according to the present disclosure-to the warehouse towers.

FIG. 34 represents a segment of an automated warehouse, wherein the workstation, such as a bending cell, is connected by three switchers to the warehouse towers.

FIG. 35 illustrates a plan view of an example of equipment combining, on the one hand, a switcher according to the present disclosure, equipped with three mobile frames and integrated into a cutting laser and, on the other hand, three switchers according to the present disclosure, equipped with two mobile frames and integrated into the towers of an automated warehouse. The equipment also includes a robot moving on a track.

FIG. 36 shows a three-dimensional view of the equipment of FIG. 35.

FIG. 37 represents a combination of different modes used for managing the supply flows of an automated cell, equipped with a switcher according to the present disclosure.

FIG. 38 illustrates different automated cells arranged around a linear automated warehouse to connect all the machines together and thus increase the unassisted operating autonomy and the operating rate of the production tool as a whole.

FIGS. 39A and 39B show in detail how the switchers according to the present disclosure are integrated into the towers of the automated warehouse, so as to avoid modifying the standard dimensions of these towers.

FIG. 40 illustrates more precisely that, during the permutation sequence of the two mobile frames of a switcher according to the present disclosure, said frames do not encroach at any time on the movement corridor of the stacker crane.

FIG. 41 represents a storage tower comprising a switcher integrated at its base, illustrating that in the stopped position, the mobile frame of the switcher and the pallet it supports are perfectly aligned with the other pallets of the storage tower.

FIG. 42 shows that in the stopped position, the height of the upper face of the mobile frame of the switcher according to the present disclosure corresponds to the lowest height accessible to the extraction system that equips the stacker crane.

FIG. 43 represents the position of a pallet on the switcher according to the present disclosure, the pallet being located within the workspace. In the stopped position, the pallet cannot be at a level lower than that of the support structures of the switcher.

FIG. 44 illustrates the offset of the axes of the bearing rollers of the mobile frames of the switcher according to the present disclosure so that the stop position of the bearing rollers of the two mobile frames, when they are symmetrically opposed, is located in the median plane of the sprockets of the gears.

FIG. 45 shows a switcher according to the present disclosure having an extended structure with an auxiliary horizontal translation device for the pallet.

FIG. 46 represents in detail a switcher according to the present disclosure integrated into a tower of an automated warehouse.

FIG. 47 illustrates a switcher with three mobile frames and an auxiliary vertical translation device for the pallet (specifically, a lifting table comprising a pantograph system bringing the center table to the same level as the other two tables).

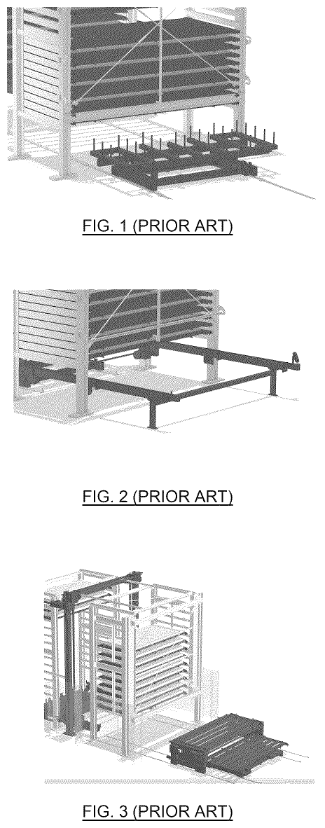

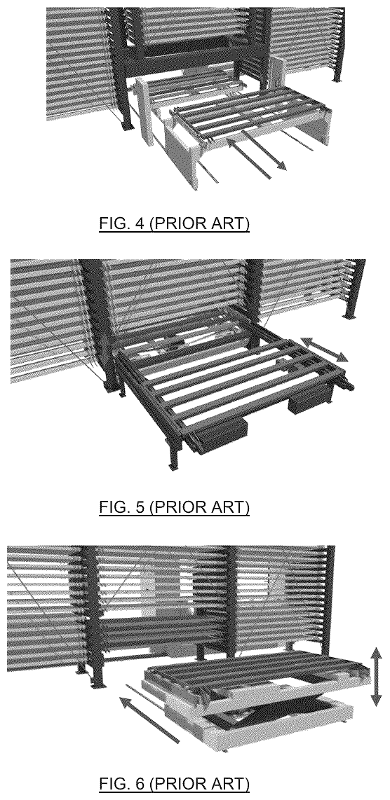

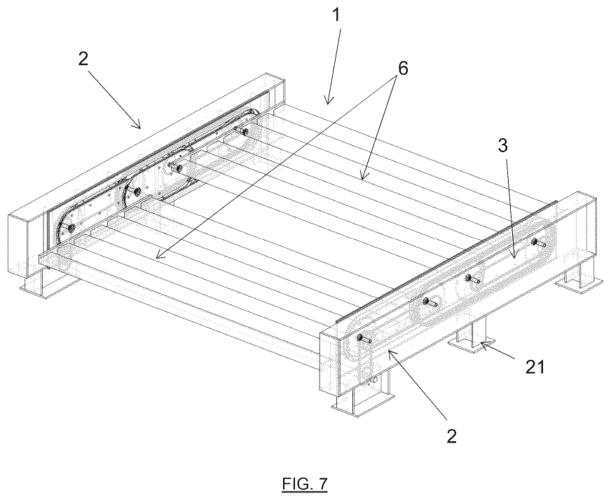

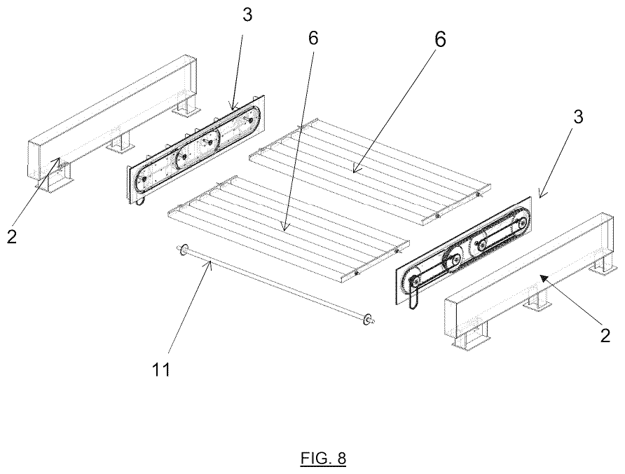

### DETAILED DESCRIPTION

The present disclosure relates to a pallet switcher/conveyor, that is to say, a system that allows simultaneous permutation of at least two pallets, one taking the place of the other or the one that follows on the conveyor and vice versa, without changing the orientation of the load to achieve real flow automation. The pallet switcher/conveyor allows the creation of a buffer stock guaranteeing production operation with limited interruptions. In the rest of the description, the pallet switcher/conveyor will simply be referred to as a “switcher”.

### Description of the Support Structure of the Pallet Switcher

The device, as illustrated in FIG. 7, consists of a support structure 2, which is formed by two parallel beams, and a conveyor system 3. The conveyor system 3 comprises a set of mechanical elements located on or integrated into each of the beams of the support structure 2, which allow the movement of at least two mobile frames 6 located between the two beams. These mobile frames 6 serve as support for handling pallets for example, in particular pallets of standard dimensions such as European pallets (EPAL).

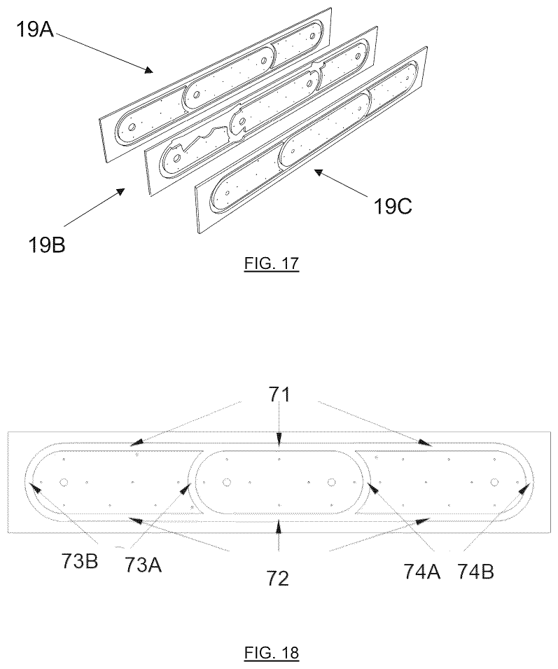

Several technical solutions can be contemplated for designing the support structure 2 of the switcher. It can either be made of standardized hot-rolled profiles (see FIG. 14) or a machine-welded assembly (FIG. 15) or even sheet-metal profiles in a “C” shape placed back to back (see FIG. 16).

The support structure 2 of the switcher 1 can be placed on the ground or spaced from it by feet 21 of variable height according to the intended application. The two parallel beams of the support structure 2 are independent or connected to each other.

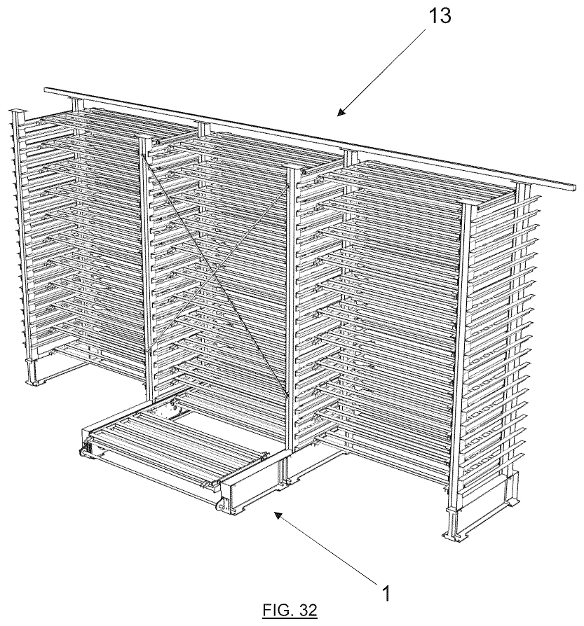

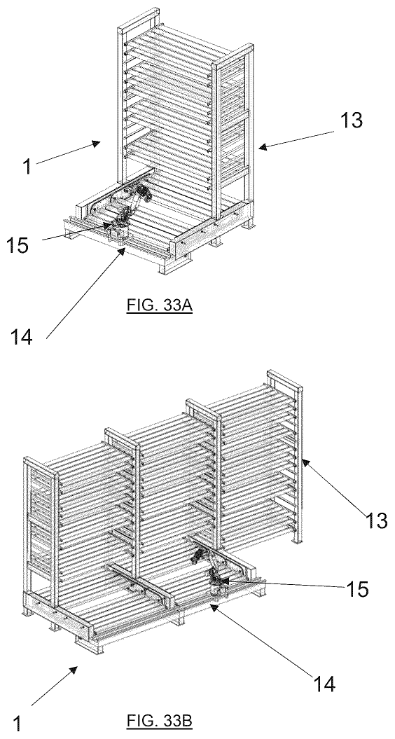

The dimensioning and design of the support structure 2 are determined by the type of application considered and by the size and weight of the elements to be supported. As the pallet switcher 1 is mainly designed to be integrated into the storage towers 13 of a linear automated warehouse (see FIG. 32), the beams of the support structure 2 are dimensioned to receive the load represented by the weight of the storage tower 13 itself, to which the weight of the palletization system 18, loaded with its content, is added.

If the structure of the switcher 1 is adapted for integrating a track 14 and a robot 15, as represented in FIGS. 33A and 33B, for example in the case of a (micro) bending cell, the beams of the support structure 2 must also have dimensions that are sufficient to support the structures of the linear axes ensuring the guidance of the robot's movements (for example ground track, suspended track) as well as the structures of the linear axes of movement of the gripping devices for the metal sheets and cut parts.

Regarding the integration of the switcher 1 into the automated warehouse, the height of the ladders (or series of racks) of the storage towers 13 associated with a switcher 1 is reduced by the height of the latter so that the ladders are aligned with those of the standard towers of the warehouse, with the same total height. The pallet switcher 1, due to its geometry, will then be advantageously compatible with the storage towers 13 of the automated warehouse.

### Description of the Mobile Frames

The mobile frames 6 are designed to receive an auxiliary palletization system 18 (see FIGS. 20, 25, 26 and 31) constituting the main support of the loads to be moved. This auxiliary palletization system 18 is made up of standardized or non-standardized pallets, the latter being compatible with the different handling devices generally used in production workshops, such as linear automated warehouse stacker cranes, automated guided vehicles (AGV), elevators, etc. As explained previously, this allows a complete integration of the switcher 1 of the present disclosure into a linear automated warehouse. This standardization of the switcher 1 and auxiliary palletization system 18 offers said switcher 1 an interface function between the different workstations of the production workshop, for example laser cutting and material transport or storage. Thus, the loads to be placed on the switcher 1 are not placed directly on the mobile frames 6 but rather via the auxiliary palletization system 18, which acts as an intermediary between the mobile frames 6 and the loads to be stored. The mobile frames are made up of two parallel arms equipped with bearing rollers and connected to each other by one or more crosspiece(s). Different configurations of mobile frames may be considered and adapted, on a case-by-case basis, to the auxiliary load supports they are intended to convey, as well as to the different handling systems generally used for moving said auxiliary load supports.

Each mobile frame is equipped with four rollers ensuring rolling and guidance of the frame during transfer operations. Two of the rollers are mechanically linked to transmission chains.

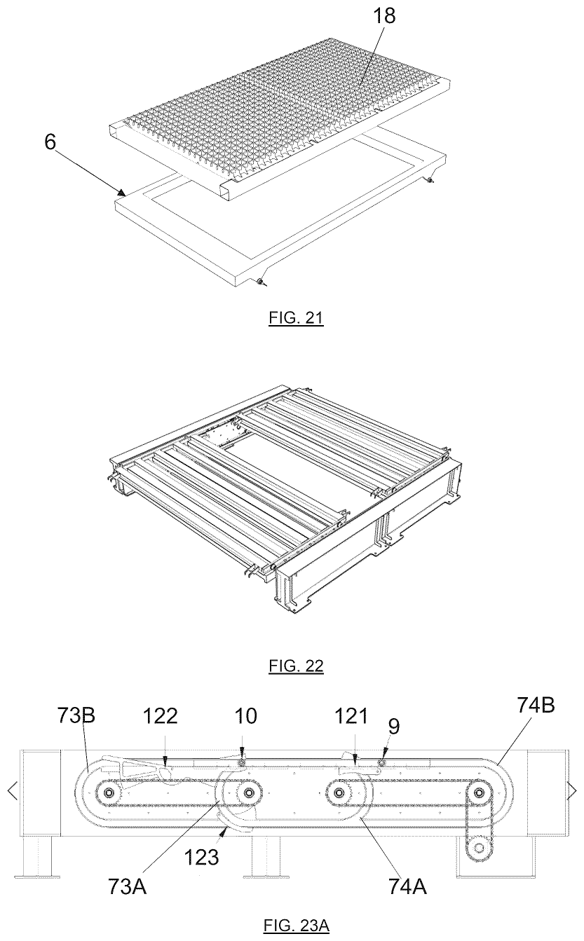

FIG. 19 describes a mobile frame designed to receive load supports consisting of standardized pallets typical of automated storage warehouses. In this case, the arms of the mobile frame serve as a bearing race for the metal pallets of the warehouse.

FIG. 20 describes a mobile frame designed to receive load supports consisting of Euro-pallets. The frame is open on one of its sides to allow the deposit or removal of Euro-pallets using a fork lift or an AGV.

FIG. 21 describes a mobile frame designed to receive a load support consisting of a comb table characteristic of laser-cutting tables.

### Description of the Conveyor System

The conveyor system 3 of the switcher 1 of the present disclosure operates in a closed loop, as detailed below, so as to switch the position of the mobile frames 6 within a few seconds. The conveyor is of the “top/bottom” type or the “return below” type, meaning that, when there are at least two mobile frames 6, one is in a high position and the other in a low position, and they exchange their positions via a movement operated by the conveyor system 3 according to a so-called double-rail or offset-rail system.

The switcher cannot be likened to a conveyor insofar as its function is not to convey multiple loads from point A to point B but rather to reverse the position of two pallets by substituting one for the other.

In the vast majority of cases, the switcher will be dedicated to a single operation and will therefore include two mobile frames moving symmetrically and oppositely to substitute for each other, the operation consisting for example in removing an empty pallet and replacing it with a loaded pallet and vice versa (see for example FIG. 22).

In the case of an operating process including two operations to be performed simultaneously, the switcher may include three mobile frames. A switcher with three mobile frames, as illustrated in FIG. 26, may for example be useful to efficiently serve a laser-cutting machine by performing, in a single operation, the removal of the metal sheet that has just been cut and the introduction of a new sheet to be cut awaiting processing.

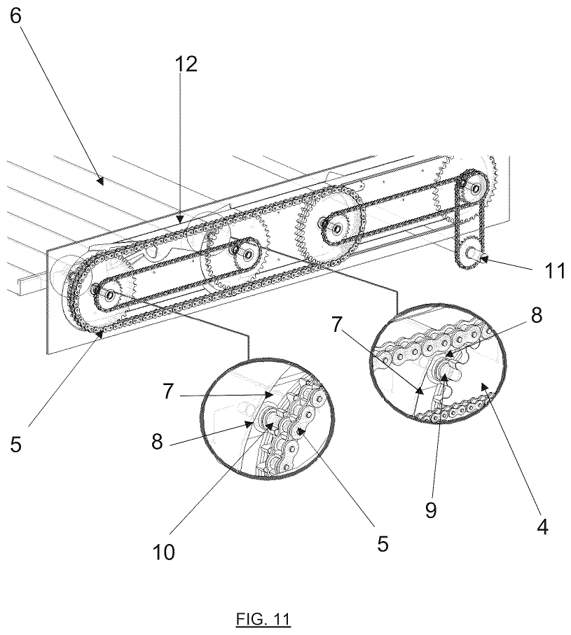

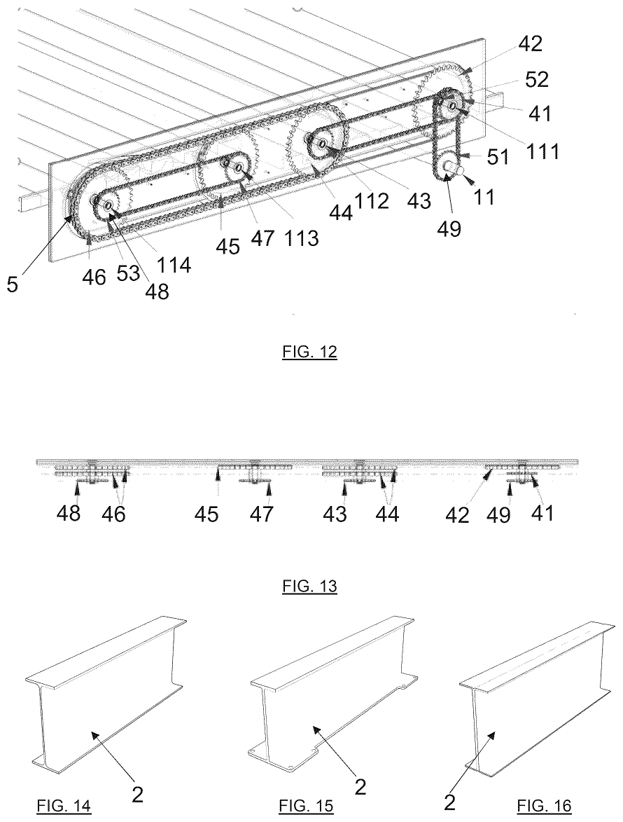

The mechanism for permuting load supports, or conveyor system 3, comprises, as explained previously, a set of mechanical elements to move the mobile frames 6. More specifically, the system includes an assembly of segments, which form the bearing and guiding grooves, as well as a transmission system consisting of a set of sprockets 4, 41-49 and transmission chains 51-53, as well as two conveyor chains 5 (FIGS. 11 and 12). The sprockets 4, 41-49 and chains 5, 51-53 form an undercarriage that facilitates the parallel and simultaneous movement of the mobile frames 6, the conveyor chains 5 driving the mobile frames 6 as explained below. In some applications where the loads to be conveyed are lighter, the sprockets 4, 41-49 and chains 5, 51-53 may be advantageously replaced by pulleys and toothed belts.

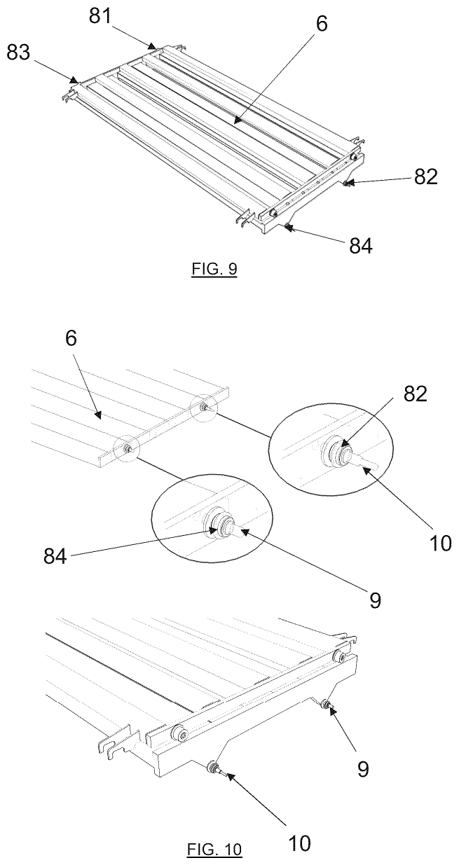

Each mobile frame 6 is equipped with bearing and guiding rollers 8, 81-84 as depicted in FIGS. 9 and 10. These are located on the lateral sides of the mobile frame 6 and cooperate with the guiding grooves 7. In the context of the present description, the so-called lateral sides of each mobile frame 6 are considered to be the sides parallel to the beams of the support structure 2 and the so-called transverse sides are those perpendicular to these beams. The mobile rollers 8 operate in pairs, a first pair (the front pair) with rollers 81 and 82 and a second pair (the rear pair) with rollers 83, 84 (see FIG. 9). In the context of the present description, the front part of the system is considered to be the part located on the side where the frame is in a forward position when it is in a high position (just before moving downward to the low position) and conversely for the rear part. Preferably, the conveyor system 3 and the guiding grooves are symmetrically distributed on or in each of the beams of the support structure so that the mobile frames 6 are moved between the two beams by the conveyor system 3.

The guiding grooves 7, as illustrated in FIG. 18, constitute a bearing race for the rollers 8 of the mobile frames 6. A characteristic element of the present disclosure lies the fact that the first pair of rollers 81 and 82 and the second pair of rollers 83, 84 of a same mobile frame 6 will take a different path within the guiding grooves 7, so that the two mobile frames 6 remain horizontal throughout their movement. The two different paths are taken due to a switching system as explained below.

More specifically, the guiding grooves 7 are detailed in FIG. 18. Groove 71 corresponds to an upper horizontal movement plane. Groove 72 corresponds to a lower horizontal movement plane. Semi-circular grooves 73A, 73B allow the downward movement from the upper plane to the lower plane while the semicircular grooves 74A, 74B allow the upward movement from the lower plane to the upper plane. The bearing races of the two pairs of rollers 8 are partially common on the horizontal parts but different at the semicircular grooves, which allows the upward and downward movements of the mobile frames 6. More specifically, grooves 71, 72, 73A, 73B, 74A, 74B defining the two aforementioned paths have an oblong shape and are horizontally offset from each other. In use, the first pair of rollers 81 and 82 will take an external path 73B for the descent and an internal path 74A for the ascent, while the second pair of rollers will take an internal path 73A for the descent and an external path 74B for the ascent. This can obviously be done in reverse, as this example is provided to ensure a good understanding of the present disclosure, just like the definitions of the front and rear parts, which depend on the direction of rotation of the rollers 8 on the closed loop, which may obviously be reversed. Given this offset-rail type of movement, a parallel movement between the two mobile frames 6 is constantly maintained. A small vertical separation between the two horizontal levels is preferable but depends on the type of application. For example, a distance of 20 to 30 cm between the horizontal planes of the two mobile frames 6 can be envisaged, although a distance of 24 cm or more if necessary is preferred.

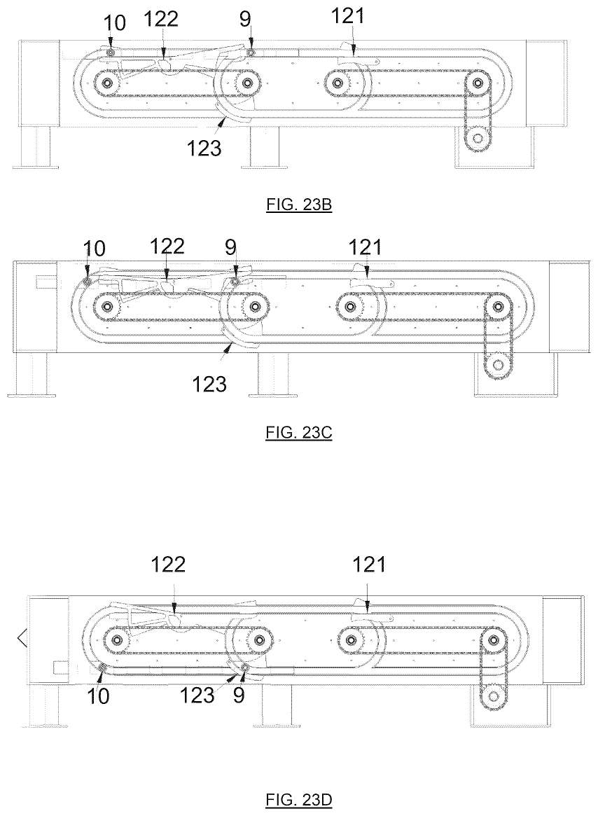

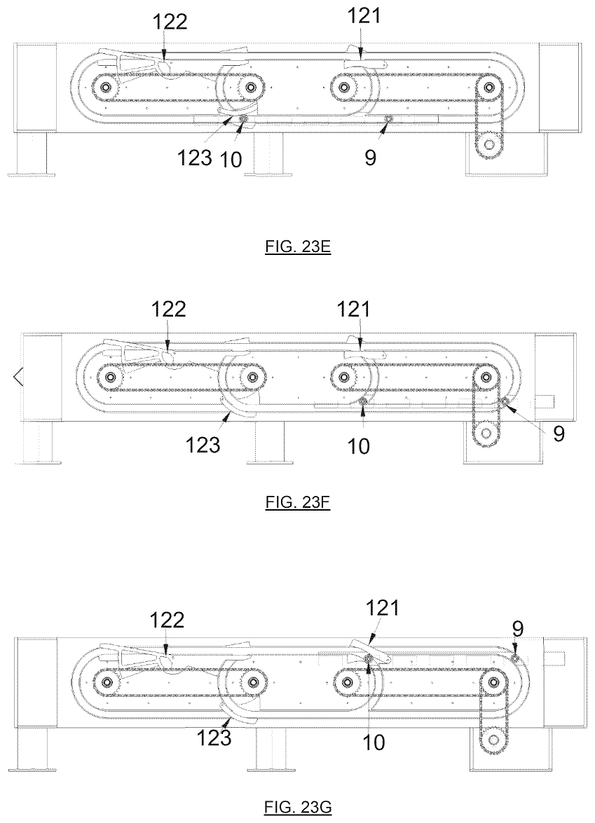

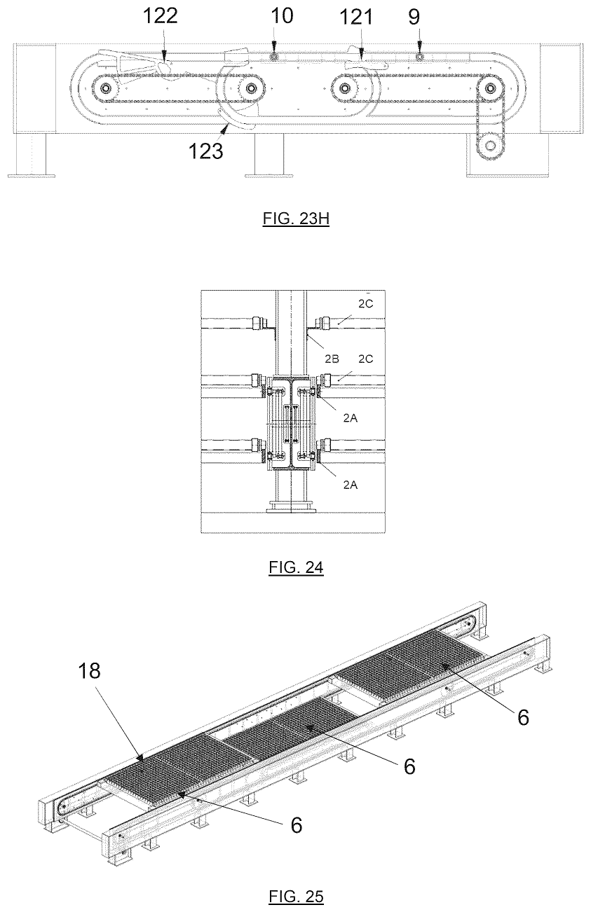

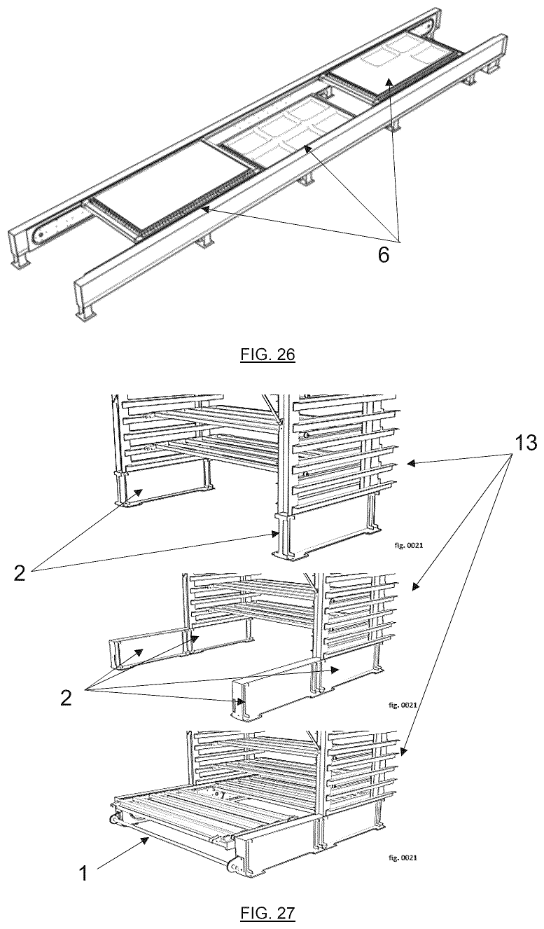

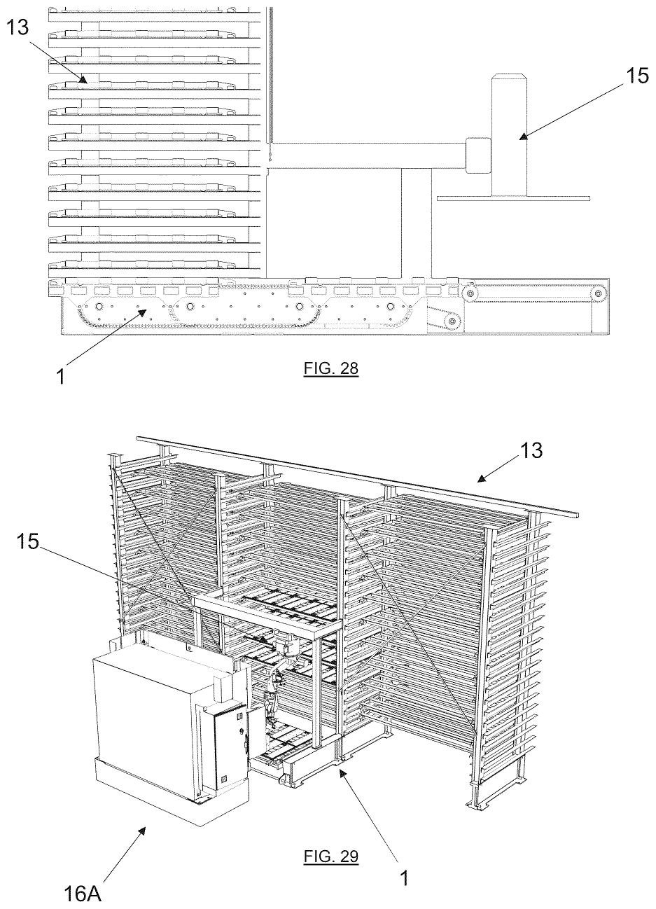

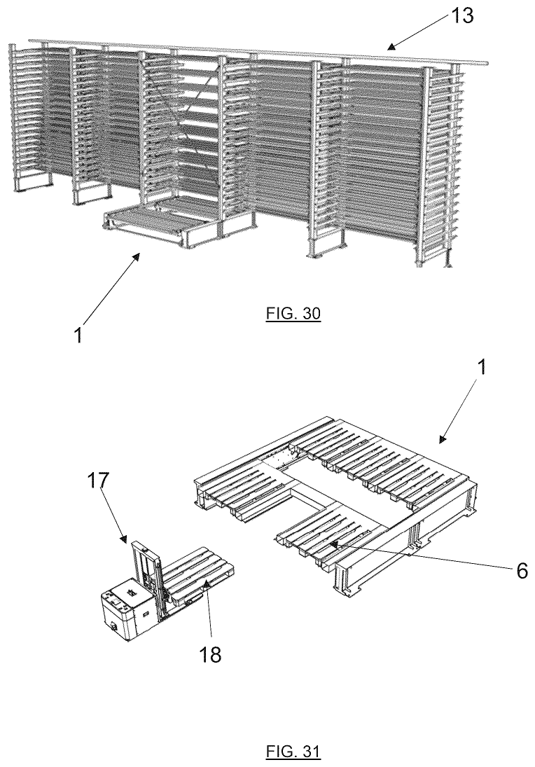

To allow the mobile frames 6 to follow the appropriate path in the grooves 7, the system is equipped with a switching system, for example, a set of cam bridges 12, 121-123 as illustrated by FIGS. 11 and 23A to 23H (specifically to guide the first and second pairs of rollers (81, 82, 10; 83, 84, 9), in the first and second paths of the guiding grooves (71, 72, 73A, 73B, 74A, 74B), respectively). The operation of an example of a switching system is described in the following section.

As represented in FIG. 25, there might be more than two mobile frames 6. The case depicted is an embodiment of a switcher with three mobile frames 6. The principle of the present disclosure remains identical, specifically a conveyor system 3 with chains, sprockets, and a switching system to correctly direct the front and rear pairs of rollers of each mobile frame 6. The number of mobile frames 6 can thus be multiplied.

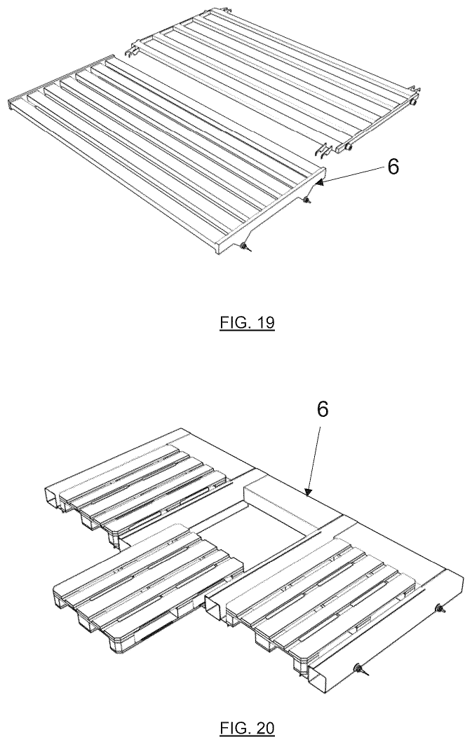

Still according to the present disclosure, to be able to support a high weight related to the specific use of the switcher 1, the guiding grooves 7 (or bearing races) of the bearing rollers will be designed in a particular way. As illustrated by FIG. 17, these grooves are made of three thick metal sheets assembled together to form bearing and guiding grooves that can withstand high mechanical stresses and support the cams. More specifically, these bearing and guiding grooves of the mobile frames comprise, as represented in FIG. 17:
A main segment 19A connected to the support structure of the switcher and forming the external part of the bearing race;
A median segment 19B that constitutes the guiding path and to which articulated cams are integrated; and
A closing segment 19C that constitutes the internal part of the bearing race.

This solution has many advantages, such as extreme simplicity, low implementation cost and compactness.

The mechanism is also characterized by the fact that it is extremely compact but still able to convey loads weighing up to several tons, even when two switchers are juxtaposed or when the mechanisms must be duplicated.

### Description of the Bearing Race of the Mobile Frames and Their Drive Principle

FIGS. 9 and 10 illustrates, in a general manner, a pair of rollers, for example the second pair of rollers 83, 84, including a protruding axis 9, thus allowing the rollers to be supported by the sprockets 4 during movements in the semicircular grooves 73A, 74B connecting the two horizontal movement planes. This is possible because the different sprockets 4 are located inside each of the aforementioned semicircles, the toothed wheel of the sprockets 4 coinciding with the semicircular grooves 73A, 74B (see FIGS. 11 and 12). The first pair of rollers 81 and 82 has an extended axis 10, which allows the rollers not only to be supported by the sprockets 4 during movements in the semicircular grooves 73B, 74A connecting the two horizontal movement planes, but also to link them to the conveyor chains 5 located on either side of the switcher 1. It should be noted that the extended axis 10 and the protruding axis 9 may be located either on the rollers of the first or second pair, depending on the position of the conveyor chains relative to the sprockets. In view of the function to be performed, the extended axis 10 is longer than the protruding axis 9.

The detailed views of FIG. 11 illustrate the principle of linking the rollers 81, 82, 10 to the conveyor chain 5 as well as the principle of accompanying the rollers 83, 84, 9 by the sprockets 4 in the upward and downward movements of the mobile frame 6.

As shown in FIG. 12, the drive shaft 11 simultaneously drives the set of sprockets located on either side of the switcher 1. The sprockets of the drive shaft 49 drives those of the shaft 111 via the chain 51. The corresponding sprocket 41 drives the sprockets of the shaft 112 via the chain 52. The sprocket 44 in turn drives the sprocket 45 of the shaft 113, which is itself connected by the chain 53 to the sprocket 48 of the shaft 114.

FIG. 13 shows the three parallel positioning planes of the sprockets as well as the arrangement of the transmission chains 51 to 53 and the conveyor chain 5. The sprockets are therefore all driven simultaneously and at the same angular speed.

### Description of the Positions of the Bearing Rollers

The position of the bearing rollers 8 (81-84) on the arms of the mobile frame 6 of a switcher 1 influences the stop position of the pallets moved by the switcher. The following explanation relates, on the one hand, to the pallet located in vertical alignment with the storage tower 13 to which the switcher is integrated, called the “warehouse pallet” 61, and, on the other hand, to the pallet located in the workspace, called the “cell pallet” 62.

In applications where the switcher is used as a functional interface between an automated warehouse and a work cell, it must simultaneously satisfy several conditions.

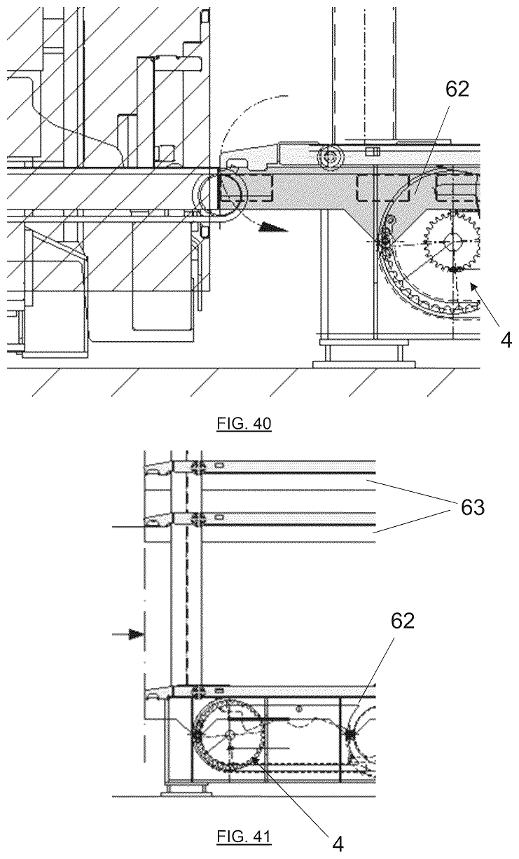

A first condition is that during the permutation sequence of the two mobile frames 6, they do not encroach at any time on the movement corridor of the stacker crane (see FIG. 40).

A second condition requires that in the stopped position, the mobile frame 6 and the pallet 62 supported by the latter are perfectly aligned with the other pallets 61 of the storage tower (see FIG. 41).

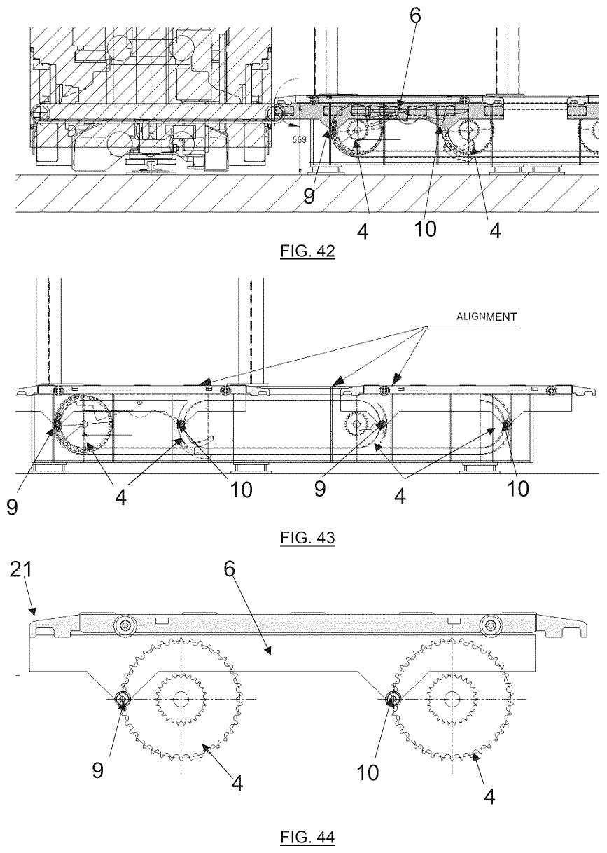

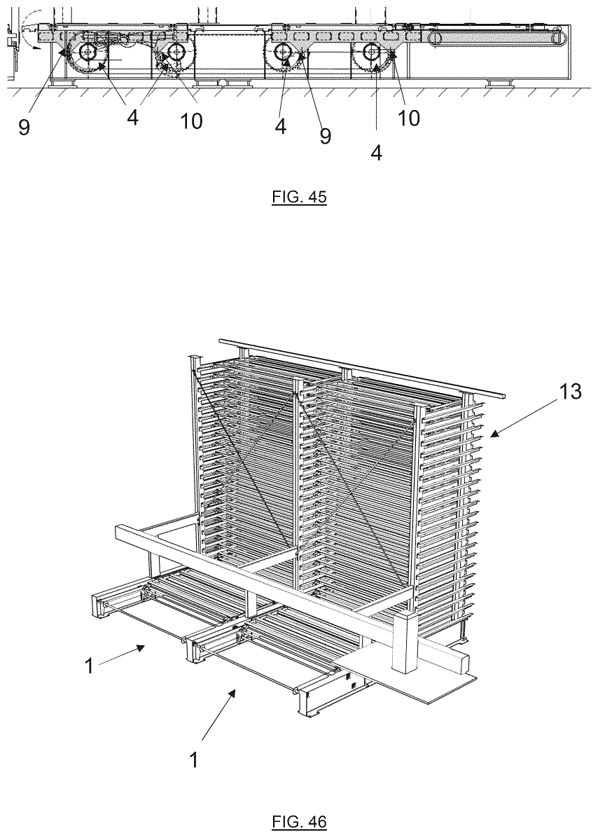

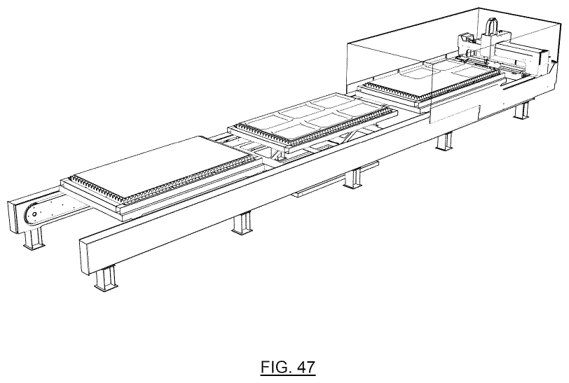

A third condition is that in the stop position, the height of the upper face of the mobile frame 6, constituting the bearing race of the pallet 25, corresponds to the lowest height accessible to the extraction system that is integrated into the stacker crane. This height varies according to the origin of the warehouse and is generally between 55 and 60 cm (see FIG. 42).

A fourth condition relates to the position of the pallet 62 located in the workspace. In the stop position, the upper plane of the pallet 62 cannot be at a level lower than that of the support structures 2 of the switcher 1, to avoid the risk of collision with the control systems used for gripping or depositing incoming and outgoing parts (see FIG. 43).

The solution that simultaneously satisfies all the conditions described in the previous paragraphs consists in offsetting the axes 9 and 10 and bearing rollers 8 of the mobile frames 6 so that the stop position of the bearing rollers 8 of the two mobile frames 6, when they are symmetrically opposed, is located in the median plane of the sprockets 4 (toothed wheels) (see FIG. 44).

In this exact position, the two pallets 62, 62 carried by the mobile frames 6 are exactly at the same level and satisfy the four aforementioned conditions:
The warehouse pallet in the stop position is perfectly aligned with the other pallets of the warehouse;
During the permutation movement, the pallet makes an inward movement and therefore does not encroach on the movement corridor of the stacker crane;
The height of the upper plane of the arms of the mobile frames places the warehouse pallet at the lowest height still accessible by the extraction system of the stacker crane;
The height of the upper plane of the cell pallet is flush with the upper plane of the support structures of the switcher or slightly protruding.

FIG. 9 shows a perspective view of a mobile frame 6 with offset axes 10 and bearing rollers 8.

### Description of a Complete Permutation Cycle of a Mobile Frame and of an Illustrative Mode of Resolution for the Routing Problems of the Bearing Rollers Via the Articulated Cam Bridges

FIGS. 23A to 23F illustrate, according to a non-limiting embodiment of the present disclosure, a complete permutation cycle of a mobile frame 6. A switching system, here illustrated by a set of cam bridges (or simply cams) 121-123, makes it possible to guide the rollers 8 in the appropriate grooves 7 so as to allow each mobile frame 6 to remain horizontal.

In FIG. 23A, the cam 122 is in a lowered position (right horizontal part, left oblique part) to prevent the roller 10 (extended axis of the first pair of rollers 81, 82) from following the first downward groove 73A it encounters. The cam 121 is also in a horizontal position to allow the roller 9 (protruding axis of the second pair of rollers 83, 84) to cross the opening formed where the upward groove 74A and the upper horizontal groove 71 meet.

In FIG. 23B, the roller 10 encounters the oblique part of the cam 122 (on the left) and tilts it horizontally, at the same time causing the right part of the cam 122 to be lifted. The roller 9 can therefore enter the downward groove 73A, the opening of which is accessible.

FIG. 23C shows the rollers 10 and 9 that have entered the two respective downward grooves 73B, 74A.

In FIG. 23D, the roller 10, driven by the chain 5 to which it is linked, reaches the groove corresponding to the lower movement plane. The same applies to roller 9, which is supported at the end of its stroke by the cam 123.

It should be noted that if roller 10 is the “front” roller and roller 9 is the “rear” roller when the mobile frame 6 is in the upper movement plane, the front/rear position of rollers 10 and 9 reverses when the mobile frame is in the lower movement plane.

In FIG. 23E, the mobile frame continues its movement within the lower horizontal groove. The roller 10 encounters the cam 123 and lifts it to continue its stroke.

In FIG. 23F, the roller 10, driven by the chain 5 to which it is secured and supported by the sprocket 44, is now in the upward groove 74A. The same applies to roller 9, which is supported during the transfer from the lower movement plane to the upper movement plane by the corresponding sprocket 42.

In FIG. 23G, to rejoin the upper horizontal groove 71, the roller 10 lifts the cam 121.

In FIG. 23H, the rollers 9 and 10 are in the upper movement groove 71. The cams 122 and 121 are again in the horizontal position. At the end of the cycle, all the cams have returned to their initial position either by gravity or by means of an ad hoc mechanism. For example, the volume of the cam 122 is hollowed out (more significantly) at its oblique side on the left, which allows it to return to its initial position by gravity as soon as roller 10 or roller 9 has passed.

### Compatibility of the Switching System With a Manual Handling Mode

In workshops where handling flows are not automated, the presence of switchers according to the present disclosure would offer a dual advantage. On the one hand, the flows entering and leaving the workstation would always be duplicated by a buffer stock guaranteeing practically uninterrupted operation of the machine and work of its operator (or operation of the cell if the machine is automated). On the other hand, the work of the handler would be made more flexible because the latter could better prioritize the handling flows between the different workstations for which they are responsible.

Some workshops are already relying on the automation of handling. The functions of workstation supply as well as removal and restocking of shaped parts are thus increasingly ensured by automated vehicles with fully programmed movements.

The switcher according to the present disclosure is compatible with many types of devices, as explained above. This makes it useful in the execution of several tasks.

As shown in FIG. 31, the pallet switcher 1 may be equipped with mobile frames 6 that are open on one of the sides perpendicular to the beams of the support structure (see also FIG. 20). This allows different types of automated vehicles to easily access the pallets, including automated vehicles without forks that can slide under the pallet, lift it and remove it from its housing.

As illustrated in FIG. 24, the lateral crosspieces 2A of the mobile frames 6 of the switcher 1 are aligned with the profiles 2B supporting the pallets with hooks 2C specific to automated warehouses, so that the pallets with hooks 2C can be transferred from the switcher 1 to one of the warehouse stalls and vice versa. In this way, the pallets are compatible with the storage towers 13, whether it is a standard storage tower or a storage tower 13 comprising a pallet switcher 1 integrated into its base. This transfer operation is carried out by a pallet elevator circulating parallel to the storage towers. The symmetry of the beam forming the support structure of the switcher 1 allows the mechanism to be duplicated when several switchers 1 are juxtaposed, while respecting the alignment with the ladders of the towers in the automated warehouse.

As explained previously, the structure of the switcher 1 may be adapted to integrate a track 14 and a robot 15, as represented in FIGS. 33A and 33B. For example, this configuration may be particularly interesting in the case of a (micro) bending cell 16A, giving it practically unlimited unassisted operating autonomy and an operating rate maximized by the presence of the switcher 1. In the configuration shown in FIG. 33B, the automated cell 16 is connected by two switchers 1 to two of the towers 13 of the automated warehouse. This double connection allows the automatic introduction of parts to be bent into the cell and the deposit of bent parts on the second switcher 1 according to a pre-established interlocking and stacking program. If there is only one single switcher 1 connecting the cell 16A and the warehouse, as shown in FIG. 33A, the switcher 1 could introduce a pallet into the microcell, which is connected to a single tower of the automated warehouse, one part of the pallet surface being occupied by flat parts to be bent and another part being left free to receive the bent parts. These same parts could also be deposited in bulk in containers placed on the pallet. The advantage of the pallet switcher of the present disclosure is that it is modular and adaptable to a whole series of devices, multiplying time savings and productivity in production workshops.

A switcher 1 configuration including three mobile frames 6 (as illustrated in FIGS. 25 and 35) is a particularly advantageous embodiment. Indeed, this embodiment makes it possible to switch three elements simultaneously in a single operation lasting a few seconds. It is particularly interesting when the method is broken down into three phases. This is for example the case for laser-cutting machines 16B, where the steps of the method, namely cutting, removing cut parts, and preparing the new metal sheet, are often carried out successively and not simultaneously, thus inducing waiting times during which the machine is not productive. This configuration also stands out for its great simplicity of design as well as its compactness.

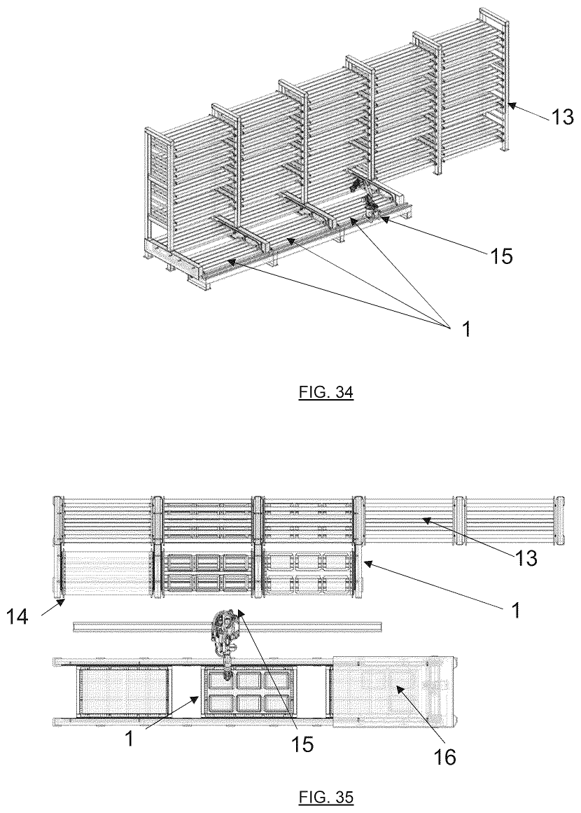

In some cases, it might be advantageous to provide a triple connection of an automated cell 16A to the warehouse (see FIG. 34). The third entry can serve-as an example and not exhaustively-to introduce, into the cell 16A, tools shared between several bending cells 16A connected to the warehouse, specific tools dedicated to a customer, elements that allow the optimization of the stacking of bent parts, large grippers, etc.

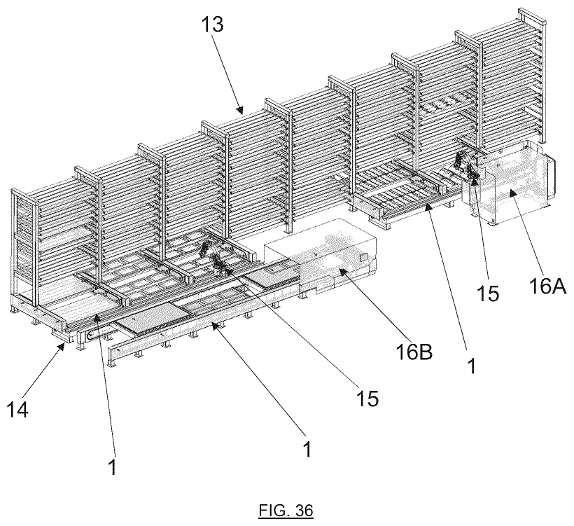

The example shown in FIGS. 35 and 36 illustrates equipment combining on the one hand a switcher 1 equipped with three mobile frames 6 (such as the one illustrated in FIG. 25) integrated into a laser cutter and, on the other hand, three switchers 1 each equipped with two mobile frames 6 integrated into the towers 13 of an automated warehouse. The equipment also includes at least one robot 15 moving on a track 14. This illustration highlights the compactness of the laser and its control system consisting of a switcher 1 with three mobile frames and a robot mounted on a track. When the laser has completed a cutting sequence, the three laser tables starts moving simultaneously to bring a new metal sheet to the machine in a few seconds, thus maximizing the operating rate of the machine. As soon as the laser begins a new cutting sequence, the robot 15 will pick up a new sheet from the first switcher 1 of the warehouse and place it on the laser table located opposite. Then, it will pick up the parts cut during the previous sequence and place them on the second switcher 1 of the warehouse. Once this work is completed, the robot 15 will remove the sheet skeleton to the third switcher 1 of the warehouse. The different grippers necessary for the robot 15 to perform the handling of parts of various sizes as well as skeletons scraps may for example be advantageously arranged on the external faces of the storage towers 13 of the warehouse. The robot 15 is dimensioned so that its extended length allows it to reach the places farthest from the laser tables or from the pallets of the warehouse switchers 1. The support structure of the switcher can be used to support the track and the robot. A variant with columns and suspended track is also conceivable (not shown).

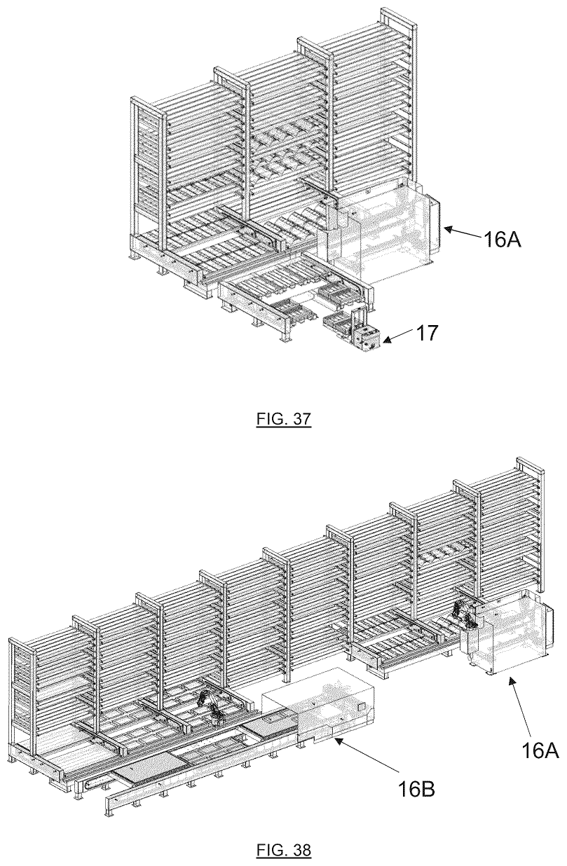

FIG. 37 illustrates a combination of different procurement flow management modes for the cell 16A. In addition to being directly connected to the automated warehouse, the cell 16A is equipped with a switcher 1 dedicated to Euro-pallets (EPAL), facing the workshop and allowing the management of part of the incoming and outgoing flows using an assisted elevator 17 or an automatically guided and programmed vehicle (AGV).

FIG. 38 illustrates how it would be possible to arrange the cutting cells 16B, such as lasers or punching machines, as well as the bending cells 16A around a linear automated warehouse to connect all the machines together and thus increase the unassisted operating autonomy and the operating rate of the production tool as a whole.

In the switchers of the prior art, very diverse loads, light or heavy, are moved parallel to themselves from a high level to a low level and vice versa, but with a large number of load supports. In the applications envisaged with the switcher according to the present disclosure, the aim is limited to simultaneously switching two or three mobile frames/pallets at the most. The number of pallets is directly linked to the machine operating sequence, a sequence consisting of replacing in a very short time an empty pallet with a full pallet or vice versa (buffer effect). In the case of applications with a laser cutter, the switcher advantageously includes three mobile frames, the operating sequence of this type of machine being based on three elements:
A table dedicated to the metal sheet being machined;
A table dedicated to the next metal sheet for machining and
A table dedicated to the metal sheet that has just been machined.

The objective is to perform the three operations simultaneously using a mechanism that stands out from the state of the art thanks to its great simplicity and compactness.

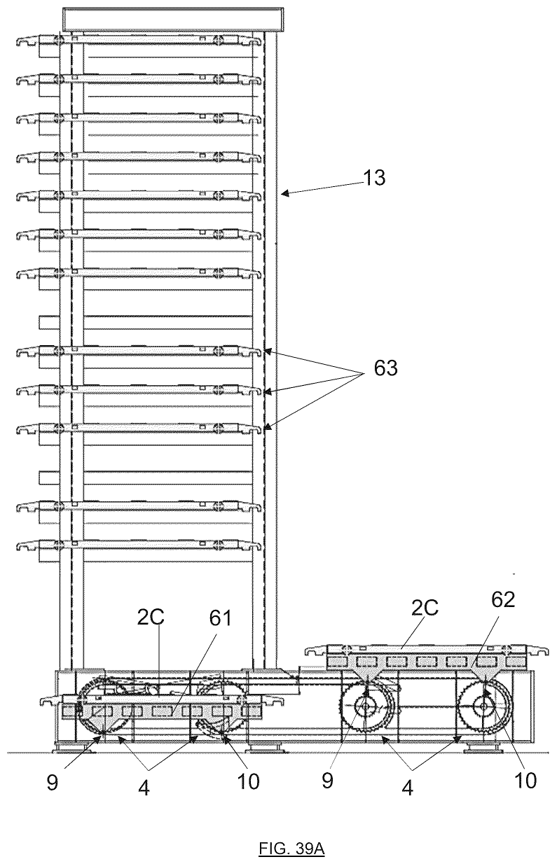

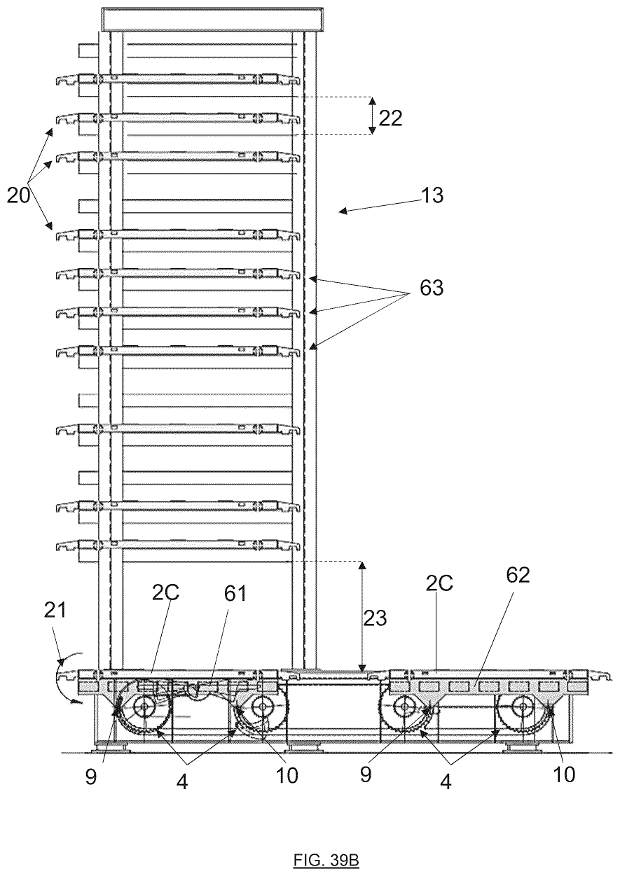

FIG. 39A shows that when the two mobile frames 61, 62 cross, the useful distance separating the top of the pallet 2C carried by the mobile frame 61, circulating in the lower bearing race, and the bottom of the structures of the mobile frame 62, which circulates in the upper plane, must allow the passage of the empty pallet or a low-height load such as a bundle of metal sheets or flat cut parts.

On the one hand, the right-hand side of FIG. 39B shows the position of a pallet 2C located inside the cutting or bending cell when the axes 9 and 10 of the mobile frame 62 are located in the median plane of the sprockets 4. The height of the mobile frame is chosen so that the top of the pallet 62 is at least flush with the support structures of the switcher or protruding from them. On the other hand, the left-hand side of the figure shows the most forward position of a pallet 61, in the situation where the axes 9 and 10 of the mobile frame are in the median plane of the sprockets 4, the pallet 61 carried by the mobile frame 2C being vertically aligned with the other pallets 63 of the warehouse. The height position of this pallet 61 must correspond to the height of the lowest point 21 accessible to the extraction system of the stacker crane.

In the storage tower 13 located above the switcher 1, as in a standard storage tower, the pallet-storage levels are equidistant. The distance 23 between the first storage level (going from bottom to top) and the maximum height of the mobile frame in the tower will then be chosen so as to be greater than the fixed distance 22 between two storage levels of the tower, to also exchange larger parts between the storage tower 13 and a workstation outside the storage tower, such as a bending cell. This distance 23 will therefore be chosen to allow, for example, the transfer of bent parts into the automated warehouse after bending.

The distance between the lowest position of pallet 63 in the warehouse and the highest position of pallet 61, 62 in the switcher during the cycle must be such that allows the passage in the interval, always from above, of the most voluminous parts, in particular bent parts.

### LIST OF REFERENCE SYMBOLS

1 Pallet switcher
2 Switcher support structure
21 Beam foot
2A Mobile frame lateral crosspiece
2B Support profile
2C Pallet with hooks
3 Conveyor system
4 Sprockets (references 41-49 for the various sprockets)
5 Conveying chain
51-53 Transmission chains
6 Mobile frame (references 61 and 62)
7 Guiding groove (references 71, 72, 73A, 73B, 74A, 74B for the different grooves)
8 Bearing and guiding roller (references 81-84 for the various rollers)
9 Protruding roller axis
10 Extended roller axis
11 Drive shaft
111-114 Transmission shafts
12 Cam bridge (references 121-123 for the various cams)
13 Storage tower (automated warehouse)
14 Track
15 Robot
16A Micro bending cell
16B Laser cutting
17 Forklift or automated vehicle
18 Direct load support system (or auxiliary palletization)
19A-19C Metal sheets forming the guiding grooves
20 Hook of the warehouse pallet
21 Lowest access point of the stacker crane in the warehouse
22 Interval between two storage levels in the storage tower
23 Interval between the first storage level in the storage tower and the maximum height of the mobile frame of the switcher

1. A system comprising a storage tower of an automated tower or vertical warehouse, comprising a palletization system having pallets and a pallet switcher integrated at the base of the tower, the tower being configured to use using palletization for the storage and transport of loads, the switcher comprising:
a support structure having beams of sufficient dimensions to receive a load represented by a weight of the storage tower and an expected maximum weight of loaded pallets;
at least two mobile frames, each of the mobile frames comprising a first pair of rollers and a second pair of rollers on lateral sides;
a conveyor system located on the support structure and configured to allow movement of the mobile frames, the conveyor system being connected to a drive shaft;
a set of guiding grooves forming a closed loop with separate rails and a guiding path for each mobile frame, the set of guiding grooves comprising a first path and a second path, the grooves accommodating the rollers of the mobile frames; and
a cam-switching system for the pairs of rollers in the guiding grooves;
wherein the cam-switching system being is configured to guide, in use, the pairs of rollers so that the first pair takes the first path and the second pair takes the second path so as to move the mobile frames along the closed loop while remaining permanently parallel to each other horizontally and oriented in the same direction;
each mobile frame being configured to carry, in use, a single pallet, the pallet being distinct from the supporting mobile frame, wherein the beams of the support structure comprise an assembly of at least three metal sheets each of the sheets comprising specific cutouts forming, in combination, the guiding grooves and housings for the cam-switching system of the pairs of rollers in the guiding grooves.

2. The system according to claim 1, wherein the weight of loaded pallets amounts to 2.5 tons.

3. The system according to claim 1, comprising at least one standard storage tower without pallet switcher, wherein the beams of the support structure of the pallet switcher are symmetrical and have a geometry configured to allow duplication of the conveyor system when several switchers are juxtaposed laterally, respecting the height alignment with the standard storage tower and with the storage tower comprising a pallet switcher integrated at its base.

4. The system according to claim 1, comprising at least one standard storage tower without pallet switcher, wherein a height of the storage tower associated with a switcher is reduced by the height of the switcher so that the storage tower is aligned with the height of a standard storage tower, the storage levels being also aligned relative to the standard tower without switcher.

5. The system according to claim 1, comprises comprising specific pallets with hooks supported by profiles, and wherein the mobile frames of the switcher comprise lateral crosspieces aligned with the profiles supporting the pallets with hooks so that the pallets with hooks are configured to be transferred, in use, from the switcher to the storage tower of the automated warehouse and vice versa, given compatibility with the switcher and the storage tower.

6. The system according to claim 1, wherein the storage tower comprises equidistant pallet-storage levels, a distance between the first storage level and a maximum height of the mobile frame in the tower is greater than a fixed distance between two storage levels of the tower so as to also exchange larger parts between the storage tower and a workstation outside the storage tower.

7. The system according to claim 1, wherein the first pair of rollers comprises an extended axis and the second pair of rollers comprises a protruding axis, and wherein the conveyor system comprises a plurality of sprockets the axes of the mobile frame being in the median plane of the sprockets, in a position that corresponds to the most forward position of a pallet on the warehouse side, the pallet carried by the mobile frame being then vertically aligned with the other pallets of the warehouse, this pallet thus being also accessible to the extraction system of a warehouse stacker crane.

8. Automated manufacturing equipment, comprising an automated warehouse and at least one bending cell and/or a laser-cutting cell, the automated warehouse comprising one or more standard storage tower(s) as well as at least one system comprising a storage tower and a pallet switcher according to claim 1 integrated at the base of said tower.

9. A pallet switcher comprising:
a support structure;
at least two mobile frames, a first mobile frame and a second mobile frame, each comprising a first pair of rollers and a second pair of rollers on lateral sides;
a conveyor system located on the support structure and configured to allow movement of the mobile frames, the conveyor system being connected to a drive shaft;
a set of guiding grooves forming a closed loop with separate rails and a guiding path for each mobile frame, the set of guiding grooves comprising a first path and a second path, the grooves accommodating the rollers of the mobile frames; and
a cam-switching system for the pairs of rollers in the guiding grooves;
wherein the cam-switching system being is configured to be suitable for guiding, in use, the pairs of rollers so that the first pair takes the first path and the second pair takes the second path so as to move the mobile frames along the closed loop while remaining permanently parallel to each other horizontally and oriented in the same direction;
each mobile frame being configured to carry, in use, a single pallet, said pallet being distinct from the supporting mobile frame;
wherein beams of the support structure comprise at least three metal sheets each of the sheets comprising specific cutouts forming, in combination, the guiding grooves and housings for the cam-switching system of the pairs of rollers in the guiding grooves.

10. Laser-cutting equipment comprising a laser-cutting cell, at least one robot moving on a track, and a switcher according to claim 9, equipped with three mobile frames for performing the operating sequence of the laser-cutting equipment, the equipment comprising:
a first table dedicated to a metal sheet being machined;
a second table dedicated to a next sheet for machining; and
a third table dedicated to a sheet that has just been machined.

11. A method for switching pallets to exchange initial positions of the first mobile frame and the second mobile frame, each of which is suitable for supporting a pallet, using the switcher of claim 9, the conveyor system of the switcher comprising conveyor chains and two set of sprockets and the cam-switching system of the switcher comprising a first, a second and a third cam, the guiding grooves of the switcher comprising a groove corresponding to an upper horizontal movement plane, a groove corresponding to a lower horizontal movement plane, two semicircular grooves allowing downward movement from the upper plane to the lower plane, and two semicircular grooves allowing upward movement from the lower plane to the upper plane, said grooves defining the two paths, which have an oblong shape and are horizontally offset from each other, the rollers of the first pair of rollers comprising an extended axis that allows the first set of sprockets to support said rollers during their movement in the semicircular grooves connecting the two horizontal movement planes, and also to link said rollers to the conveyor chains, the rollers of the second pair of rollers comprising a protruding axis, allowing the second set of sprockets to support said rollers during their movement in the semicircular grooves connecting the two horizontal movement planes, the method comprising:
at the beginning of a cycle, the conveyor system is activated when the first mobile frame is in position on the upper horizontal movement plane, each roller of the first pair of rollers having its extended axis driven by the conveyor chain and being suitable for engaging with the sprockets during movements in the semicircular grooves connecting the two horizontal movement planes; and each roller of the second pair of rollers having its protruding axis suitable for engaging with the sprockets during movements in the semicircular grooves connecting the two horizontal movement planes;
the roller of the first pair of rollers thus being driven, reaches the intersection of the upper horizontal groove with the first downward groove;
the first cam of the cam-switching system located at this intersection being in a lowered position, the first cam comprising a straight part followed by an oblique part, the bearing roller of the first pair of rollers remains guided in the upper horizontal groove and then in the second downward groove thanks to the sprocket, the encounter of the roller with the oblique part of the first cam lifting said cam, the oblique part being tilted to the horizontal and the straight part being lifted, thus freeing the passage in the first downward groove for the bearing roller of the second pair of rollers;
the second cam of the cam-switching system located at the intersection of the upper horizontal groove with the first upward groove in a horizontal position, the bearing roller of the second pair of rollers crosses the opening to the first upward groove and continues its path in the upper horizontal groove;
the first cam being lifted, the bearing roller of the second pair of rollers is guided in the first downward groove;
when the bearing roller of the first pair of rollers reaches the lower horizontal groove, it is driven further in this groove by the conveyor chain while the bearing roller of the second pair of rollers simultaneously reaches the third cam of the cam-switching system at the end of its stroke in the first downward groove, said third cam being in a lowered position, thereby allowing the roller of the second pair of rollers to pass;
the mobile frame continues its movement in the lower horizontal groove and the bearing roller of the first pair of rollers lifts the third cam to continue its stroke;
the bearing roller of the second pair of rollers supported by the sprocket, is driven into the second upward groove, and the bearing roller of the first pair of rollers supported by the sprocket, is driven into the first upward groove, thus allowing transfer from the lower movement plane to the upper movement plane;
the bearing roller of the first pair of rollers reaches the upper horizontal groove by lifting the second cam and simultaneously with the bearing roller of the second pair of rollers;
the first mobile frame returns to its initial position in the upper horizontal groove and the second cam and first cam are either in a lowered position for the next cycle by gravity or are returned to a lowered position by means of an ad hoc mechanism;
the movements are similar for the second mobile frame, which is at the beginning of the cycle in position on the lower horizontal movement plane.
